(19) United States
(12) Patent Application Publication
(10) Pub. No.: US 2016/0345324 A1
(43) Pub. Date: Nov. 24, 2016

(54) DATA TRANSMISSION METHOD AND DEVICE

(71) Applicant: HUAWEI DEVICE CO., LTD., Shenzhen, Guangdong (CN)

(72) Inventors: Guiming SHU, Shenzhen (CN); Su LU, Shenzhen (CN); Zhiming DING, Shenzhen (CN)

(21) Appl. No.: 14/902,300

(22) PCT Filed: Oct. 30, 2013
(86) PCT No.: PCT/CN2013/086260

§ 371 Date: Dec. 30, 2015

(51) Int. Cl. H04W 72/04; H04W 74/04; H04H 20/38

(52) U.S. Cl. CPC H04W 72/0453; H04H 20/38; H04W 74/04; H04W 88/08

(57) ABSTRACT

Embodiments of the present invention disclose a data transmission method and a device, and belong to the field of communications technologies. In one embodiment, the method includes: sending a broadcast message, where the broadcast message carries information about a sending window that is allocated for a data receiving terminal and that is used to send a trigger message, and the trigger message sending window includes at least one sending opportunity used by the data receiving terminal to send the trigger message; receiving the trigger message sent by the data receiving terminal, and allocating, for the terminal sending the received trigger message, a channel resource used to receive data; and returning channel resource allocation information to the terminal sending the received trigger message, and sending, by using the allocated channel resource, the data to the terminal sending the received trigger message.

### TECHNICAL FIELD

The present invention relates to the field of communications technologies, and in particular, to a data transmission method and a device.

### BACKGROUND

In a wireless local area network, in order to save electric energy, a terminal generally works alternately in an awake state and a sleeping state according to a specific rule. However, when the terminal works in the sleeping state, data cannot be transmitted in time because a message sent by a network-side device cannot be received. A data transmission rate is an important criterion for measuring a wireless network. Therefore, in a power saving state, how to transmit data significantly affects the development of the wireless network.

In the prior art, during data transmission, by way of example, a terminal is a STA (Station, station) and a network-side device is an AP (Access Point, access point). The STA periodically receives a broadcast message sent by the AP, and determines, according to an indication bit in the broadcast message sent by the AP, whether there is data for reception. If there is data for reception, after detecting an idle channel, each data receiving STA starts a backoff mechanism, and randomly selects a backoff time between a minimum backoff time and a maximum backoff time that are set. When an accumulative time in which the channel is idle reaches the backoff time selected by the STA, the STA reaching the backoff time sends a PS-Poll (Power Save Poll, power save poll) message to the AP by using the entire channel. After the AP successfully receives the PS-Poll message sent by the STA, the STA receives, by using the entire channel, data transmitted by the AP. Obviously, if two or more STAs select a same backoff time after detecting an idle channel, when an accumulative time in which the channel is idle reaches the backoff time, these STAs simultaneously send PS-Poll messages to the AP, so as to trigger the AP to send buffered data.

In a process of implementing the present invention, the inventors find that the prior art has at least the following problem:

In the prior art, during data transmission, when two or more STAs select a same backoff time, PS-POLL messages that are simultaneously sent by the two or more STAs conflict. In this case, the STAs need to re-perform channel competition. Because channel competition of multiple STAs is performed on an entire channel on which an AP works, a data transmission manner provided in the prior art causes a waste of resources of the entire channel.

### SUMMARY

To solve a problem in the prior art, embodiments of the present invention provide a data transmission method and a device. The technical solutions are as follows:

According to a first aspect, a data transmission method is provided, where the method includes:

sending a broadcast message, where the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

receiving the trigger message sent by the data receiving terminal, and allocating, for the terminal sending the received trigger message, a channel resource used to receive data, where the terminal sending the received trigger message sends the received trigger message according to the at least one sending opportunity in the trigger message sending window that is carried in the broadcast message; and

returning channel resource allocation information to the terminal sending the received trigger message, and sending, by using the allocated channel resource, the data to the terminal sending the received trigger message, so that the terminal sending the received trigger message receives, according to the channel resource allocation information, the data on the channel resource allocated for the terminal sending the received trigger message, where the channel resource includes a subchannel that is used and corresponding use time.

With reference to the first aspect, in a first possible implementation manner of the first aspect, before the sending a broadcast message, the method further includes:

dividing a channel into a preset quantity of subchannels, and determining a subcarrier included in each subchannel; and

determining a quantity of data receiving terminals, and determining a quantity of sending opportunities according to the quantity of data receiving terminals, where the sending opportunity is determined by the trigger message sending time and the subchannel that is used.

With reference to the first aspect, in a second possible implementation manner of the first aspect, before the sending a broadcast message, the method further includes:

dividing a channel into a preset quantity of subchannels, and determining a subcarrier included in each subchannel; and

allocating a corresponding trigger message sending opportunity for each data receiving terminal, so that information about the allocated trigger message sending opportunity is carried in the subsequently sent broadcast message.

According to a second aspect, a data transmission method is provided, where the method includes:

receiving a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

sending the trigger message to the network-side device according to the at least one sending opportunity in the trigger message sending window that is carried in the broadcast message, so that the network-side device allocates a channel resource used to receive data, where the channel resource includes a subchannel that is used and corresponding use time; and receiving channel resource allocation information that is returned by the network-side device, and receiving, according to the allocation information, the data on the channel resource allocated by the network-side device.

With reference to the second aspect, in a first possible implementation manner of the second aspect, the sending the trigger message to the network-side device according to the at least one sending opportunity in the trigger message sending window that is carried in the broadcast message includes:

sending the trigger message to the network-side device according to at least one sending opportunity randomly selected from the trigger message sending window that is carried in the broadcast message.

With reference to the second aspect, in a second possible implementation manner of the second aspect, the sending the trigger message to the network-side device according to the at least one sending opportunity in the trigger message sending window that is carried in the broadcast message includes:

sending the trigger message to the network-side device according to a corresponding sending opportunity specified in the trigger message sending window that is carried in the broadcast message.

According to a third aspect, a network-side device is provided, where the device includes:

a first sending module, configured to send a broadcast message, where the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

a receiving module, configured to receive the trigger message sent by the data receiving terminal;

an allocating module, configured to allocate, for the terminal sending the received trigger message, a channel resource used to receive data, where the terminal sending the received trigger message sends the received trigger message according to the at least one sending opportunity in the trigger message sending window that is carried in the broadcast message;

a returning module, configured to return channel resource allocation information to the terminal sending the received trigger message; and

a second sending module, configured to send, by using the allocated channel resource, the data to the terminal sending the received trigger message, so that the terminal sending the received trigger message receives, according to the allocation information, the data on the channel resource allocated for the terminal sending the received trigger message, where the channel resource includes a subchannel that is used and corresponding use time.

With reference to the third aspect, in a first possible implementation manner of the third aspect, the device further includes:

a first preprocessing module, configured to: divide a channel into a preset quantity of subchannels, and determine a subcarrier included in each subchannel; and determine a quantity of data receiving terminals, and determine a quantity of sending opportunities according to the quantity of data receiving terminals, where the sending opportunity is determined by the trigger message sending time and the subchannel that is used.

With reference to the third aspect, in a second possible implementation manner of the third aspect, the device further includes:

a second preprocessing module, configured to: divide a channel into a preset quantity of subchannels, and determine a subcarrier included in each subchannel; and allocate a corresponding trigger message sending opportunity for each data receiving terminal, so that information about the allocated trigger message sending opportunity is carried in the subsequently sent broadcast message.

According to a fourth aspect, a terminal is provided, where the terminal includes:

a first receiving module, configured to receive a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

a sending module, configured to send the trigger message to the network-side device according to the at least one sending opportunity in the trigger message sending window that is carried in the broadcast message, so that the network-side device allocates a channel resource used to receive data, where the channel resource includes a subchannel that is used and corresponding use time;

a second receiving module, configured to receive channel resource allocation information that is returned by the network-side device; and

a third receiving module, configured to receive, according to the allocation information, the data on the channel resource allocated by the network-side device.

With reference to the fourth aspect, in a first possible implementation manner of the fourth aspect, the sending module is configured to send the trigger message to the network-side device according to at least one sending opportunity randomly selected from the trigger message sending window that is carried in the broadcast message.

With reference to the fourth aspect, in a second possible implementation manner of the fourth aspect, the sending module is configured to send the trigger message to the network-side device according to a sending opportunity specified in the trigger message sending window that is carried in the broadcast message.

According to a fifth aspect, a network-side device is provided, where the network-side device includes a processor, a transmitter, and a receiver, where

the processor is configured to generate a broadcast message, and allocate, for a terminal sending a received trigger message, a channel resource used to receive data, where the channel resource includes a subchannel that is used and corresponding use time, the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

the transmitter is configured to: send the broadcast message, generate allocation information about the channel resource that is allocated for the terminal sending the received trigger message, and return the channel resource allocation information to the terminal sending the received trigger message; and generate data that is to be sent to the terminal sending the received trigger message, and send, by using the allocated channel resource, the data to the terminal sending the received trigger message, so that the terminal sending the received trigger message receives, according to the channel resource allocation information, the data on the channel resource allocated for the terminal sending the received trigger message; and

the receiver is configured to receive the trigger message sent by the data receiving terminal, where the terminal sending the received trigger message sends the received trigger message according to the at least one sending opportunity in the trigger message sending window that is carried in the broadcast message.

With reference to the fifth aspect, in a first possible implementation manner of the fifth aspect, the processor is further configured to: divide a channel into a preset quantity of subchannels, and determine a subcarrier included in each subchannel; and determine a quantity of data receiving terminals, and determine a quantity of sending opportunities according to the quantity of data receiving terminals, where the sending opportunity is determined by the trigger message sending time and the subchannel that is used.

With reference to the fifth aspect, in a second possible implementation manner of the fifth aspect, the processor is further configured to: divide a channel into a preset quantity of subchannels, and determine a subcarrier included in each subchannel; and allocate a corresponding trigger message sending opportunity for each data receiving terminal, so that information about the allocated trigger message sending opportunity is carried in the subsequently sent broadcast message.

According to a sixth aspect, a terminal is provided, where the terminal includes a processor, a transmitter, and a receiver, where

the receiver is configured to receive a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

the processor is configured to control, according to the at least one sending opportunity in the trigger message sending window that is carried in the broadcast message, the transmitter to send the trigger message to the network-side device, so that the network-side device allocates a channel resource used to receive data, where the channel resource includes a subchannel that is used and corresponding use time; and

the receiver is further configured to receive channel resource allocation information that is returned by the network-side device, and receive, according to the allocation information, the data on the channel resource allocated by the network-side device.

With reference to the sixth aspect, in a first possible implementation manner of the sixth aspect, that the processor controls, according to the at least one sending opportunity in the trigger message sending window that is carried in the broadcast message, the transmitter to send the trigger message to the network-side device specifically includes: controlling, according to at least one sending opportunity randomly selected from the trigger message sending window that is carried in the broadcast message, the transmitter to send the trigger message to the network-side device.

With reference to the sixth aspect, in a second possible implementation manner of the sixth aspect, that the processor controls, according to the at least one sending opportunity in the trigger message sending window that is carried in the broadcast message, the transmitter to send the trigger message to the network-side device specifically includes: controlling, according to at least one sending opportunity specified in the trigger message sending window that is carried in the broadcast message, the transmitter to send the trigger message to the network-side device.

The technical solutions provided in the embodiments of the present invention bring the following beneficial effects:

a broadcast message carries a sending opportunity that is allocated for a data receiving terminal and that includes trigger message sending time and information about a subchannel that is used, and the broadcast message is sent, so that multiple data receiving terminals may simultaneously send trigger messages according to at least one sending opportunity in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a data transmission method according to Embodiment 1 of the present invention;

FIG. 2 is a flowchart of another data transmission method according to Embodiment 1 of the present invention;

FIG. 3 is a flowchart of a data transmission method according to Embodiment 2 of the present invention;

FIG. 4 is a schematic structural diagram of a channel obtained by division according to Embodiment 2 of the present invention;

FIG. 5 is a flowchart of a data transmission method according to Embodiment 3 of the present invention;

FIG. 6 is a schematic structural diagram of a channel obtained by division according to Embodiment 3 of the present invention;

FIG. 7 is a schematic structural diagram of a first network device according to Embodiment 4 of the present invention;

FIG. 8 is a schematic structural diagram of a second network device according to Embodiment 4 of the present invention;

FIG. 9 is a schematic structural diagram of a third network device according to Embodiment 4 of the present invention;

FIG. 10 is a schematic structural diagram of a terminal according to Embodiment 5 of the present invention;

FIG. 11 is a schematic structural diagram of a network-side device according to Embodiment 6 of the present invention;

FIG. 12 is a schematic structural diagram of a terminal according to Embodiment 7 of the present invention; and

FIG. 13 is a schematic structural diagram of a data transmission system according to Embodiment 8 of the present invention.

### DESCRIPTION OF EMBODIMENTS

To make the objectives, technical solutions, and advantages of the present invention clearer, the following further describes the embodiments of the present invention in detail with reference to the accompanying drawings.

### Embodiment 1

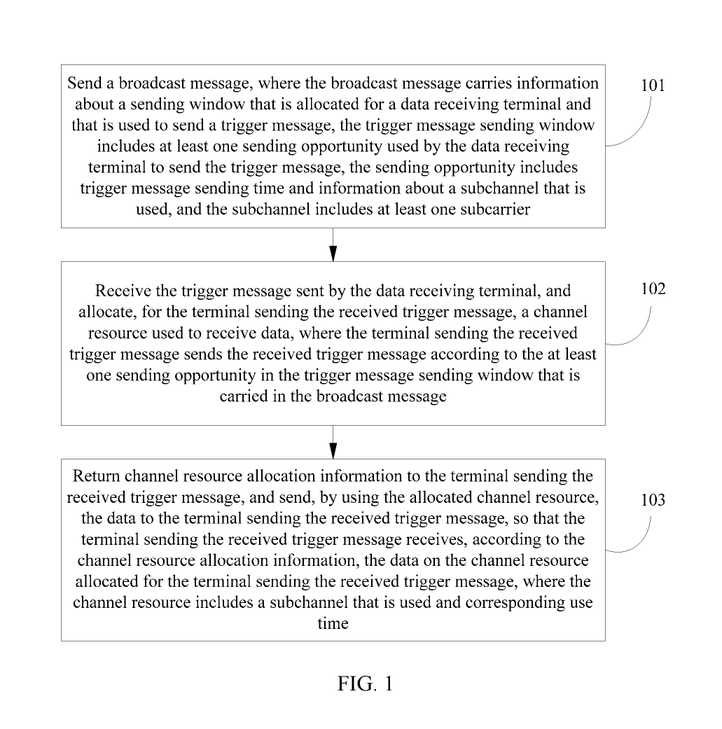

This embodiment of the present invention provides a data transmission method. Using an example in which a network-side device executes this method, referring to FIG. 1, a method procedure provided in this embodiment includes:

101: Send a broadcast message, where the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier.

102: Receive the trigger message sent by the data receiving terminal, and allocate, for the terminal sending the received trigger message, a channel resource used to receive data, where the terminal sending the received trigger message sends the received trigger message according to the at least one sending opportunity in the trigger message sending window that is carried in the broadcast message.

103: Return channel resource allocation information to the terminal sending the received trigger message, and send, by using the allocated channel resource, the data to the terminal sending the received trigger message, so that the terminal sending the received trigger message receives, according to the allocation information, the data on the channel resource allocated for the terminal sending the received trigger message, where the channel resource includes a subchannel that is used and corresponding use time.

In an exemplary embodiment, before the sending a broadcast message, the method further includes:

dividing a channel into a preset quantity of subchannels, and determining a subcarrier included in each subchannel; and

determining, according to a quantity of data receiving terminals, a quantity of sending opportunities carried in the broadcast message, and determining trigger message sending time and subcarrier information that are included in each sending opportunity.

In an exemplary embodiment, before the sending a broadcast message, the method further includes:

dividing a channel into a preset quantity of subchannels, and determining a subcarrier included in each subchannel; and

allocating a corresponding trigger message sending opportunity for each data receiving terminal, so that information about the allocated trigger message sending opportunity is carried in the subsequently sent broadcast message.

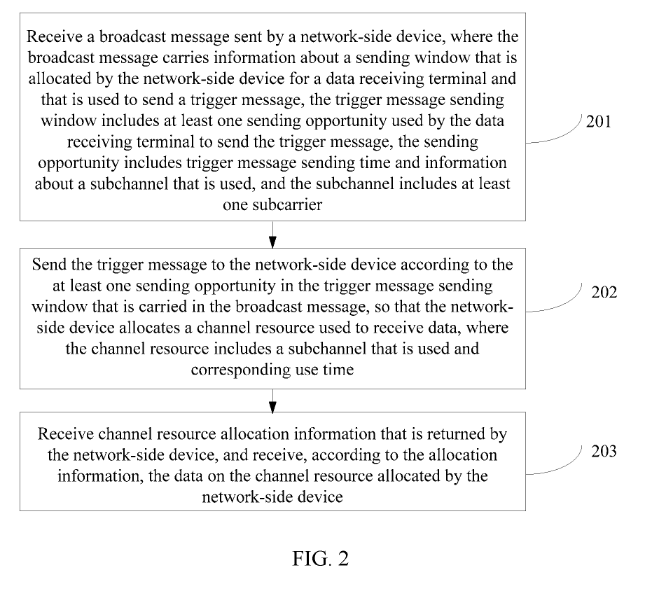

Using an example in which a terminal executes this method, referring to FIG. 2, a method procedure provided in this embodiment includes:

201: Receive a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier.

202: Send the trigger message to the network-side device according to the at least one sending opportunity in the trigger message sending window that is carried in a broadcast message frame, so that the network-side device allocates a channel resource used to receive data, where the channel resource includes a subchannel that is used and corresponding use time.

203: Receive channel resource allocation information that is returned by the network-side device, and receive, according to the allocation information, the data on the channel resource allocated by the network-side device.

In an exemplary embodiment, the sending the trigger message to the network-side device according to the at least one sending opportunity in the trigger message sending window that is carried in the broadcast message includes:

sending the trigger message to the network-side device according to at least one sending opportunity randomly selected from the trigger message sending window that is carried in the broadcast message.

In an exemplary embodiment, the sending the trigger message to the network-side device according to the at least one sending opportunity in the trigger message sending window that is carried in the broadcast message includes:

sending the trigger message to the network-side device according to a sending opportunity specified in the trigger message sending window that is carried in the broadcast message.

According to the method provided in this embodiment, a broadcast message carries a sending opportunity that is allocated for a data receiving terminal and that includes trigger message sending time and information about a subchannel that is used, and the broadcast message is sent, so that multiple data receiving terminals may simultaneously send trigger messages according to at least one sending opportunity in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### Embodiment 2

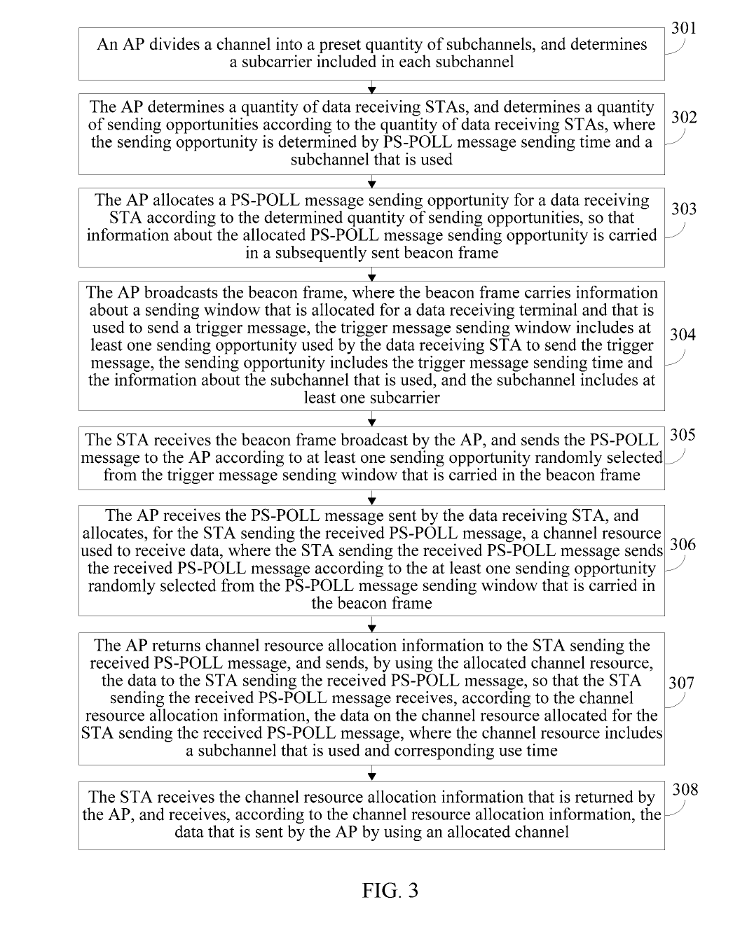

This embodiment of the present invention provides a data transmission method. With reference to the content of the foregoing Embodiment 1, the data transmission method provided in this embodiment is explained and described in detail by using an example in which a broadcast message is sent in a form of a broadcast beacon frame, a network-side device is an AP, a terminal is a STA, the AP does not define a sending opportunity corresponding to the STA, and a trigger message that is sent by the STA to the AP is a PS-POLL message. Referring to FIG. 3, a method procedure provided in this embodiment includes:

301: An AP divides a channel into a preset quantity of subchannels, and determines a subcarrier included in each subchannel.

In this step, the channel is a medium of data transmission. In the communications field, data transmission needs to be performed by using a channel. Each channel may be divided into multiple subchannels, and each subchannel may be used to transmit data. Therefore, in order to save resources and avoid a waste of channel resources, a channel may be divided into a preset quantity of subchannel, and each subchannel includes a specific quantity of subcarriers. On a spectrum, these subcarriers may be nonconsecutive; or may be consecutive, where two adjacent subcarriers partially overlap on the spectrum. The preset quantity may be determined according to a communication requirement. This embodiment sets no specific limitation on the preset quantity. A method used by the AP to divide a channel into a preset quantity of subchannels includes but is not limited to a method of averagely dividing a channel into multiple subchannels, which is not specifically limited in this embodiment. Different data is transmitted on different subchannels. Therefore, according to different transmitted data, subchannels may be classified into uplink subchannels and downlink subchannels. The uplink subchannel is used by a STA to send a PS-POLL message to the AP, and the downlink subchannel is used by the AP to transmit data to the STA. A channel is formed by multiple orthogonal subcarriers. Therefore, each subchannel obtained by division is also formed by one or more subcarriers. A quantity of subcarriers included in each uplink subchannel and a quantity of subcarriers included in each downlink subchannel may be the same or may be different. Specifically, a quantity of subcarriers included in an uplink subchannel and a quantity of subcarriers included in a downlink subchannel may be 1, or may be 2, or certainly, may be another value, which is not specifically limited in this embodiment. In addition, it should be noted that an uplink subchannel may correspond to one or more subcarriers same as that of a downlink subchannel, except that a subchannel is called an uplink subchannel when the subchannel is used to send uplink data, and is called a downlink subchannel when the subchannel is used to send downlink data.

302: The AP determines a quantity of data receiving STAs, and determines a quantity of sending opportunities according to the quantity of data receiving STAs, where the sending opportunity is determined by PS-POLL message sending time and a subchannel that is used.

In this step, because data that needs to be transmitted is in one-to-one correspondence with data receiving STAs, when determining the quantity of data receiving STAs, the AP may determine, according to a mapping relationship between the data that needs to be transmitted and the data receiving STAs, the quantity of data receiving STAs.

Further, when the quantity of sending opportunities is determined according to the determined quantity of data receiving STAs, the quantity of STAs that may receive data may be equal to the determined quantity of sending opportunities. For example, when the quantity of data receiving STAs is 5, the AP determines, according to the quantity of data receiving STAs, that the quantity of sending opportunities carried in a beacon frame is also 5. When the quantity of data receiving STAs is 8, the AP determines, according to the quantity of data receiving STAs, that the quantity of sending opportunities carried in a beacon frame is also 8. Obviously, if two STAs select a same sending opportunity to send PS-POLL messages, the two sent PS-POLL messages conflict. Therefore, in order to reduce a conflict of PS-POLL messages when each data receiving STA selects one PS-POLL message sending opportunity to send a PS-POLL message, it is usually preset in the beacon frame that the quantity of sending opportunities is greater than the quantity of data receiving STAs. For example, when the quantity of data receiving STAs is 5, the AP determines, according to the determined quantity of data receiving STAs, that the quantity of sending opportunities carried in the beacon frame is any value greater than 5, for example, may determine that the quantity of sending opportunities carried in the beacon frame is 6, 7, or the like. When the quantity of data receiving STAs is 8, the AP determines, according to the determined quantity 8 of data receiving STAs, that the quantity of sending opportunities carried in the beacon frame is any value greater than 8, for example, may determine that the quantity of sending opportunities carried in the beacon frame is 10, 12, or the like.

Each PS-POLL message sending opportunity is defined by information that includes but is not limited to PS-POLL message sending time, a subchannel that is used, and the like. This embodiment poses no limitation on specific content of a sending opportunity. Because at least one of the PS-POLL message sending time and information about the subchannel that is used, which are included in each sending opportunity, is different, and the PS-POLL sending time and the subchannel that is used, which are included in each sending opportunity, are determined, a sending opportunity may be determined according to PS-POLL message sending time and a subchannel that is used.

It should be noted that the process of performing subchannel division and a sending opportunity, which is described in the foregoing step 301 and step 302, is not necessarily executed each time when the method provided in this embodiment is executed, that is, after subchannel division is performed and the sending opportunity is determined by performing the foregoing step 301 and step 302, if the method provided in this embodiment is executed again, it is only required to directly apply the subchannel obtained by division and the determined sending opportunity. Certainly, when new subchannel division needs to be performed or new sending opportunity needs to be determined, the foregoing step 301 and step 302 may be executed again, which is not specifically limited in this embodiment.

303: The AP allocates a PS-POLL message sending opportunity for a data receiving STA according to the determined quantity of sending opportunities, so that information about the allocated PS-POLL message sending opportunity is carried in a subsequently sent beacon frame.

In this step, because the AP has determined, in step 302, the quantity of sending opportunities according to the quantity of data receiving STAs, in this step, the AP may allocate the PS-POLL message sending opportunity for the data receiving STA according to the determined quantity of sending opportunities. In addition, in this step, the AP does not specify which data receiving STA for which each sending opportunity is allocated, and PS-POLL message sending time and information about a subchannel that is used, which are included in the sending opportunity allocated by the AP, include but are not limited to the following three cases:

Case 1: PS-POLL message sending opportunities that are allocated by the AP for data receiving STAs include same PS-POLL message sending time but include different sub channel information.

In this case, although sending time in PS-POLL message sending opportunities that are allocated by the AP for multiple data receiving STAs is the same, the multiple data receiving STAs may use, within the same time, different subchannels to send PS-POLL messages to the AP, thereby decreasing a possibility that a conflict occurs when different data receiving STAs send PS-POLL messages to the AP.

Case 2: PS-POLL message sending opportunities that are allocated by the AP for multiple data receiving STAs include different sending time and different subchannel information.

In this case, the multiple data receiving STAs may use, at the different time, different subchannel resources to send PS-POLL messages to the AP, so as to decrease a possibility that a conflict occurs when different data receiving STAs send PS-POLL messages to the AP.

Case 3: PS-POLL message sending opportunities that are allocated by the AP for multiple data receiving STAs include different sending time but include a same subchannel.

In this case, the multiple data receiving STAs may use, at the different time, the same subchannel resource to send PS-POLL messages to the AP, so as to decrease a possibility that a conflict occurs when different data receiving STAs send PS-POLL messages to the AP.

In addition, when the AP allocates PS-POLL message sending opportunities for multiple data receiving STAs, the AP may avoid, by monitoring neighboring wireless environments of the AP, selecting a subcarrier spectrum band surrounded with interference, so as to decrease impact on receiving, by the AP, PS-POLL messages sent by the STAs.

304: The AP broadcasts the beacon frame, where the beacon frame carries information about a sending window that is allocated for the data receiving STA and that is used to send a trigger message, the PS-POLL message sending window includes at least one sending opportunity used by the data receiving STA to send the PS-POLL message, the sending opportunity includes the PS-POLL message sending time and the information about the subchannel that is used, and the subchannel includes at least one subcarrier.

In this step, when the AP has data for transmission, the AP sends an indication to the data receiving STA in a manner of broadcasting the beacon frame, so as to notify which STAs need to receive data. Specific content in the beacon frame broadcast by the AP includes but is not limited to information such as an indication bit in a TIM (Traffic Indication Map, data transmission indication map) element, and a sending window, which is not limited in this embodiment. The PS-POLL message sending window that is carried in the beacon frame broadcast by the AP includes the at least one sending opportunity used by the data receiving STA to send the PS-POLL message, and the PS-POLL message sending opportunity in this step is the sending opportunity determined in step 302. Therefore, in this step, each sending opportunity also includes PS-POLL message sending time and subchannel information, and each subchannel includes at least one subcarrier.

In addition, the indication bit in the TIM element is formed by some binary bits, and a sequence number of each binary bit corresponds to an AID of a STA, that is, each binary bit on the indication bit in the TIM element corresponds to one STA. That is, for each STA, a unique value of a binary bit that corresponds to the STA may be found on the indication bit in the TIM element in the beacon frame broadcast by the AP. Therefore, the AP may send, to a STA in a network according to a value of a binary bit on the indication bit in the TIM element, an indication whether there is data that needs to be received. For example, when a value of a binary bit on the indication bit in the TIM element is 1, it indicates that a STA corresponding to the binary bit needs to receive data; when a value of a binary bit on the indication bit in the TIM element is 0, it indicates that a STA corresponding to the binary bit does not need to receive data. Certainly, alternatively, when a value of a binary bit on the indication bit in the TIM element is 0, it indicates that a STA corresponding to the binary bit needs to receive data; when a value of a binary bit on the indication bit in the TIM element is 1, it indicates that a STA corresponding to the binary bit does not need to receive data. In addition, besides the foregoing indication manners, another indication manner may also be available. This embodiment poses no specific limitation on a manner used by the AP to send, to a STA in a network according to a value of a binary bit on the indication bit in the TIM element, an indication whether there is data that needs to be received.

For ease of understanding, by way of example, there are five STAs (STA1, STA2, STA3, STA4, and STA5) in a network in which the AP is located, and a value 1 indicates that there is data that needs to be received. Therefore, the indication bit in the TIM element includes five binary bits. If STA1 and STA3 need to receive data, values of binary bits on the indication bit in the TIM element are 10100.

It should be noted that because the beacon frame carries the information about the sending window that is allocated for the data receiving STA and that is used to send the trigger message, where the PS-POLL message sending window includes the at least one sending opportunity used by the data receiving STA to send the PS-POLL message, and in this embodiment, the AP does not define the sending opportunity corresponding to the STA, the sending opportunity carried in the beacon frame broadcast by the AP is randomly allocated for the data receiving STA.

305: The STA receives the beacon frame broadcast by the AP, and sends the PS-POLL message to the AP according to at least one sending opportunity randomly selected from the trigger message sending window that is carried in the beacon frame.

In this step, a STA working in a power saving mode periodically wakes up according to a wake-up cycle agreed with the AP to receive the beacon frame broadcast by the AP, and views a value of a corresponding binary bit on the indication bit in the TIM element in the beacon frame broadcast by the AP. In this embodiment, by way of example, a value “1” of a corresponding binary bit on the indication bit in the TIM element indicates that there is data that needs to be received. Therefore, if a STA views and finds that a value of a binary bit corresponding to the STA on the indication bit in the TIM element in the beacon frame is “1”, the STA determines that the STA is a data receiving STA. The STA may select at least one sending opportunity from the PS-POLL message sending opportunities indicated in the beacon frame, and send a PS-POLL message to the AP according to PS-POLL message sending time and subchannel information that correspond to the selected sending opportunity. Specifically, a manner used by each data receiving STA to select a sending opportunity from the beacon frame is randomly selecting at least one sending opportunity from the beacon frame.

Specifically, in this embodiment, because the AP does not specify which data receiving STA for which the sending opportunity carried in the beacon frame is allocated, each data receiving STA may randomly select a sending opportunity from the beacon frame, and each data receiving STA has an equal opportunity to select a sending opportunity from the beacon frame. In this case, a conflict may exist when two or more STAs randomly select a same sending opportunity. For this case of conflict, in order to avoid a waste of channel resources due to competition, in the subsequent step, the AP does not allocate channel resources to STAs that send conflicted PS-POLL messages. Even so, compared with the prior art in which an entire channel resource is used to send a trigger message, the method provided in this embodiment divides an entire channel resource into multiple subchannels, so that multiple STAs are allowed to use different subchannel resources to send trigger messages at a same time, that is, an opportunity to send trigger messages increases, which may effectively decrease a possibility of a conflict generated when data receiving STAs send trigger messages.

306: The AP receives the PS-POLL message sent by the data receiving STA, and allocates, for the STA sending the received PS-POLL message, a channel resource used to receive data, where the STA sending the received PS-POLL message sends the received PS-POLL message according to the at least one sending opportunity randomly selected from the PS-POLL message sending window that is carried in the beacon frame.

In this step, after the data receiving STA sends the PS-POLL message according to the at least one sending opportunity randomly selected from the trigger message sending window that is carried in the beacon frame, the AP receives the PS-POLL message sent by the data receiving STA, and allocates, for a STA that sends a PS-POLL message that does not conflict with another message, that is, the STA sending the received PS-POLL message, the channel resource used to receive the data. When allocating, for the STA sending the received PS-POLL message, the channel resource used to receive the data, the AP may allocate a corresponding channel resource for the STA according to an amount of data that needs to be received by each STA sending the received PS-POLL message, where the channel resource herein includes at least a subchannel and corresponding subchannel occupation time. It should be noted herein that the channel resource used by the STA to receive the data is a channel resource used by the AP to send buffered downlink data to the STA. In order to avoid a conflict between channel resources allocated for multiple STAs, an allocation manner used by the AP to allocate, for each STA sending the received PS-POLL message, a channel resource for receiving data, where the channel resource includes at least time when the STA receives the data and corresponding subchannel information, includes but is not limited to the following three manners:

Manner 1: The AP allocates, for each STA sending the received PS-POLL message, same time and a different subchannel for receiving the data.

In this case, multiple STAs sending the received PS-POLL messages may use, at a same time, different subchannels to receive data transmitted by the AP.

Manner 2: The AP allocates, for each STA sending the received PS-POLL message, different time and a different subchannel for receiving the data.

In this case, multiple STAs sending the received PS-POLL messages may use, at different time, different subchannels to receive data transmitted by the AP.

Manner 3: The AP allocates, for each STA sending the received PS-POLL message, different time and a same subchannel for receiving the data.

In this case, multiple STAs sending the received PS-POLL messages may use, at different time, a same subchannel to receive data transmitted by the AP.

307: The AP returns channel resource allocation information to the STA sending the received PS-POLL message, and sends, by using the allocated channel resource, the data to the STA sending the received PS-POLL message, so that the STA sending the received PS-POLL message receives, according to the channel resource allocation information, the data on the channel resource allocated for the STA sending the received PS-POLL message, where the channel resource includes a subchannel that is used and corresponding use time.

In this step, after allocating, for the STA sending the received PS-POLL message, the channel resource used to receive the data, the AP returns the channel resource allocation information to the STA sending the received PS-POLL message. For an indication manner used by the AP to return the allocated channel resource to the STA sending the received PS-POLL message, this embodiment poses no specific limitation. During specific implementation, after the PS-POLL message sending window ends, the AP may return, by broadcasting, a channel resource allocation frame carrying the information about the channel resource allocated for the STA, to the STA sending the received PS-POLL message. The channel resource allocation frame is used as the returned channel resource allocation information. The channel resource information included in the channel resource allocation frame includes at least information about an allocated subchannel and corresponding use time. It should be noted that when returning, by broadcasting, the channel resource allocation frame carrying the information about the allocated channel resource, to the STA sending the received PS-POLL message, the AP may send, by broadcasting, the channel resource allocation frame by using an entire channel, and carry, in the channel resource allocation frame, information about channel resources allocated for all STAs sending the received PS-POLL message; or concurrently send, by using different subchannels, respective frames carrying channel resource allocation information to all STAs sending the received PS-POLL message. Optionally, after receiving the PS-POLL message, the AP may also simultaneously send, by using different subchannels, respective acknowledgement frames to all STAs sending the received PS-POLL message, and carry channel resource allocation information in the acknowledgement frames. Obviously, when the AP uses this manner to indicate the channel resource allocation information, acknowledgement frame sending time for the PS-POLL message needs to be reserved for the AP after the PS-POLL message sending opportunity. Alternatively, the AP may also broadcast multiple channel resource allocation frames by using a same subchannel at different time, so as to return information about an allocated channel resource to each STA sending the received PS-POLL message.

It should be noted that no matter whether the AP returns, by broadcasting a channel resource allocation frame or by sending multiple channel resource allocation frames, the information about the allocated channel resource to all STAs sending the received PS-POLL message, in order to differentiate between channel resource information corresponding to all STAs successfully sending the PS-POLL message, information that is about each allocated channel resource and carried in the channel resource allocation frame sent by the AP may further include a corresponding STA identifier, so that each STA that receives the channel resource allocation frame can determine, according to the STA identifier included in the channel resource information, whether the channel resource is a channel resource that is allocated by the AP for the STA. Alternatively, another manner is used to identify which STA to which the channel resource information carried in the channel resource allocation frame corresponds to. This embodiment does not limit a manner of differentiating between channel resource information corresponding to all STAs sending the received PS-POLL message.

In addition, besides the foregoing several described manners used by the AP to indicate the channel resource allocation information for the STA, the AP may further use another manner of indicating the channel resource allocation information, which is not specifically limited in this embodiment. No matter which manner is used to indicate the channel resource allocation information, after allocating, for the STA sending the received PS-POLL message, the channel resource used to receive the data, the AP may send, by using the allocated channel resource, the data to the STA sending the received PS-POLL message.

308: The STA receives the channel resource allocation information that is returned by the AP, and receives, according to the channel resource allocation information, the data that is sent by the AP by using an allocated channel.

In this step, this embodiment does not limit a manner used by the STA to receive the channel resource allocation information that is returned by the AP. In the foregoing step, if the AP returns the channel resource allocation information in a manner of broadcasting the channel resource allocation frame, and the manner in which the channel resource information includes the STA identifier is used to differentiate which STA to which the channel resource information corresponds, after receiving the channel resource allocation frame sent by the AP, the STA may determine, according to the STA identifier included in the channel resource information in the channel resource allocation frame, whether the channel resource information is information about a channel resource that is allocated by the AP for the STA.

No matter which manner is used by the AP to return the channel resource allocation information, the allocation information can indicate the channel resource that is allocated by the AP for the STA, and the channel resource information includes at least the sub channel used when the data is received and the corresponding use time. Therefore, the STA may receive, at the allocated time and on the allocated subchannel, the data transmitted by the AP, thereby implementing data transmission.

Further, in order to enable the AP to confirm a data transmission result, in the method provided in this embodiment, after successfully receiving the data transmitted by the AP, the STA further sends an ACK (Acknowledgement, acknowledgement) message to the AP, so that after receiving the ACK message sent by the STA, the AP confirms, according to the ACK message, that a transmission process of the data transmitted for the STA is complete. The STA may send, within preset time after the data transmission is complete, the ACK message to the AP on the subchannel used when the data sent by the AP is received; or the STA may also concurrently send, within preset time after the data transmission is complete, the ACK message to the AP on the subchannel used when the PS-POLL message is sent. Certainly, another manner may also be available to send the ACK message, which is not specifically limited in this embodiment. Likewise, a length of the preset time is not limited either.

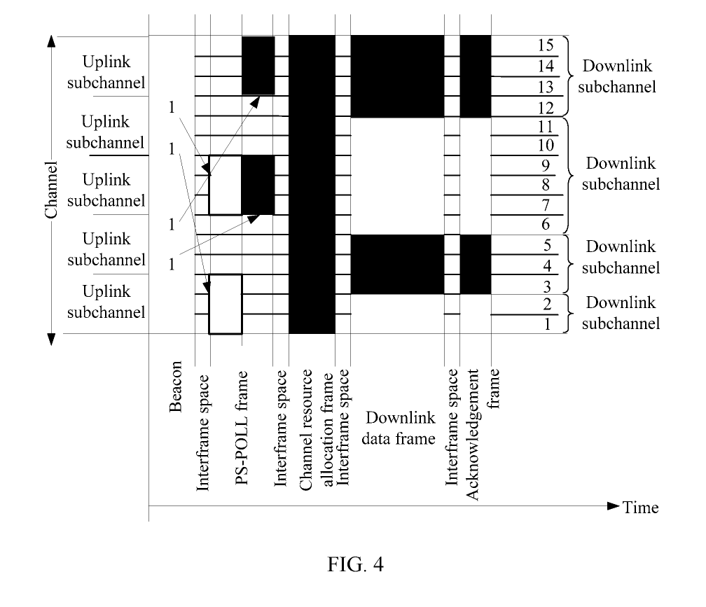

For ease of understanding of the foregoing data transmission process, detailed explanations and descriptions are provided with reference to FIG. 4.

It can be seen from FIG. 4 that a channel is divided into 15 subcarriers, where the 15 subcarriers are first grouped into five uplink channels and each uplink subchannel includes three subcarriers. An AP determines, according to an amount of data that needs to be transmitted, that a quantity of data receiving STAs is 4, and further determines that a quantity of sending opportunities included in a sending window that is carried in a broadcast beacon frame and that is used to send a trigger message to a data receiving STA should be greater than or equal to 4. In this case, by way of example, the quantity of sending opportunities carried in the beacon frame is 10. In addition, the AP further uses, in the broadcast beacon frame, a value of a binary bit on an indication bit in a TIM element to indicate which STA is a data receiving STA. The AP broadcasts one beacon frame by using the entire channel. The beacon frame carries 10 sending opportunities, and values of four binary bits on an indication bit in a TIM element are 1, which indicates that STAs corresponding to the four binary bits in the indication bit in the TIM element are data receiving STAs, that is, there are four data receiving STAs. After receiving the beacon frame broadcast by the AP, a STA in a network determines, according to the indication bit in the TIM element in the beacon frame, whether the STA is a data receiving STA. A STA that is determined as a data receiving STA randomly selects one sending opportunity from the 10 sending opportunities carried in the beacon frame broadcast by the AP, and sends a PS-POLL message to the AP by using the selected sending opportunity. After successfully receiving the PS-POLL message sent by the STA, the AP broadcasts, by using the entire channel, a channel resource allocation frame carrying information about channel resources allocated for all STAs sending the received PS-POLL message, where each piece of channel resource information includes a corresponding STA identifier, so as to send, to the four STAs sending the received PS-POLL message, the channel resource allocated by the AP. After receiving the channel resource allocation frame broadcast by the AP, each STA determines, according to the STA identifier included in the channel resource information carried in the channel resource allocation frame, whether the channel resource is a channel resource allocated by the AP for the STA. After the four STAs sending the received PS-OLL message determine their respective corresponding channel resource information, where the channel resource information includes a subchannel used when the data is received and corresponding use time, the four STAs sending the received PS-POLL message may receive, at corresponding data receiving time and on a corresponding subchannel, the data that is transmitted by the AP to the STAs. When the AP transmits the data, the entire channel is divided into four downlink subchannels, and a quantity of subcarriers included in each subchannel is divided according to a size of the data received by each STA. Further, after receiving the data, each STA returns an ACK message to the AP by using the subchannel on which the data is received.

According to the method provided in this embodiment, a broadcast message carries a sending opportunity that is allocated for a data receiving terminal and that includes trigger message sending time and information about a subchannel that is used, and the broadcast message is sent, so that multiple data receiving terminals may simultaneously send trigger messages according to at least one sending opportunity in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### Embodiment 3

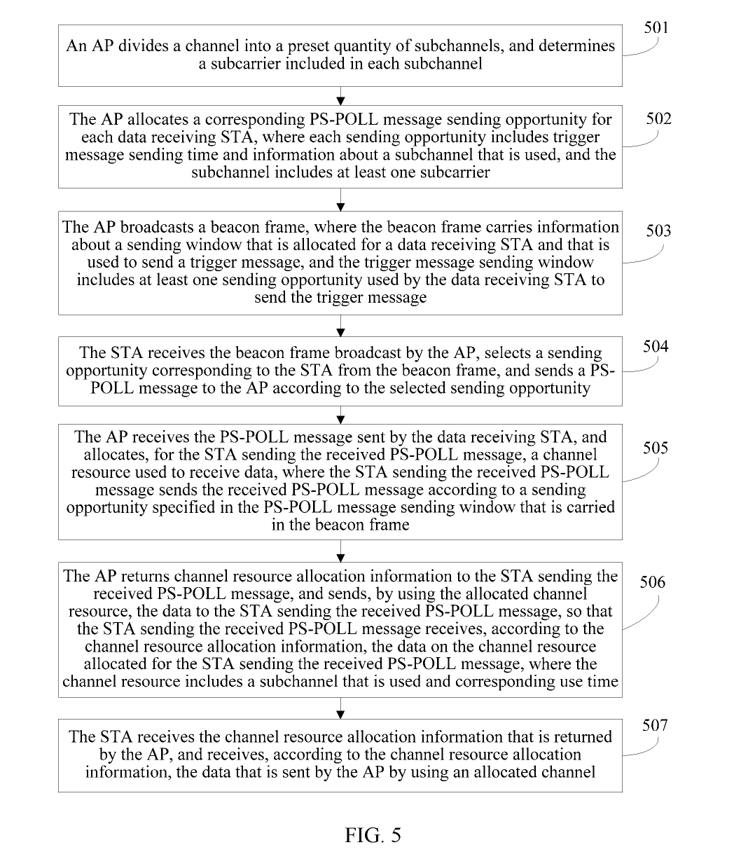

This embodiment of the present invention provides a data transmission method. With reference to the content of the foregoing Embodiment 1, the data transmission method provided in this embodiment is explained and described in detail by using an example in which a broadcast message is sent in a form of a broadcast beacon frame, a network-side device is an AP, a terminal is a STA, the AP definitely specifies a corresponding sending opportunity for each data receiving STA, and a trigger message that is sent by the STA to the AP is an uplink PS-POLL message. Referring to FIG. 5, a method procedure provided in this embodiment includes:

501: An AP divides a channel into a preset quantity of subchannels, and determines a subcarrier included in each subchannel.

In this step, a principle of a specific implementation manner of dividing a channel into a preset quantity of subchannels and determining a subcarrier included in each subchannel is same as that of the implementation manner of step 301 in the foregoing Embodiment 2. Reference may be made to the content of step 301 in the foregoing Embodiment 2, and details are not described herein again.

502: The AP allocates a corresponding PS-POLL message sending opportunity for each data receiving STA, where each sending opportunity includes trigger message sending time and information about a subchannel that is used, and the subchannel includes at least one subcarrier.

By executing this step, it is avoided that a PS-POLL message conflict occurs because two or more different data receiving STAs use a same sending opportunity to send PS-POLL messages to the AP. Therefore, before performing data transmission, the AP allocates a different PS-POLL message sending opportunity for each data receiving STA. For a manner used by the AP to allocate a different PS-POLL message sending opportunity for each data receiving STA, this embodiment poses no specific limitation. If a quantity of data receiving STAs is M, where M is a positive integer greater than 1, the AP may still correspondingly allocate M sending opportunities according to a quantity of data receiving STAs that are indicated in a TIM element, and according to a sequence number of an indication bit “1” that corresponds to a data receiving STA in the TIM element, for example, the M sending opportunities are first numbered sequentially from 1. If a bit “1”, corresponding to a STA, in the TIM element is the third bit “1” in the TIM element, the STA uses a sending opportunity whose number is 3 to send a trigger message. During specific implementation, another rule may also be used to allocate a corresponding sending opportunity for each data receiving STA, thereby ensuring that PS-POLL message sending time and a subchannel that is used, which are allocated for each data receiving STA, do not conflict.

When allocating the corresponding PS-POLL message sending opportunity for each data receiving STA, the AP may keep away from, by monitoring neighboring wireless environments of the AP, a subcarrier spectrum band surrounded with interference, so as to avoid affecting reception of a PS-POLL message sent by the STA.

It should be noted that the process described in the foregoing step 501 and step 502 is not necessarily executed each time when the method provided in this embodiment is executed, that is, after the foregoing step 501 and step 502 are executed, if the method provided in this embodiment is executed again, it is only required to directly apply the multiple subchannels divided from the channel in the foregoing step 501, and the corresponding sending opportunity allocated for each data receiving STA in step 502. Certainly, when the channel is divided into multiple new subchannels and a new corresponding sending opportunity is allocated for each data receiving STA, the foregoing step 501 and step 502 may still be executed again, which is not specifically limited in this embodiment.

503: The AP broadcasts a beacon frame, where the beacon frame carries information about a sending window that is allocated for a data receiving STA and that is used to send a trigger message, and the trigger message sending window includes at least one sending opportunity used by the data receiving STA to send the trigger message.

In this step, when there is data that needs to be transmitted, the AP sends, in a manner of broadcasting the beacon frame, an indication to a STA that is to receive the data transmitted by the AP. Specifically, a principle of a manner used by the AP to send, in a manner of broadcasting the beacon frame, an indication to a STA that is to receive the data transmitted by the AP is same as that of the manner used by the AP to broadcast the beacon frame in the foregoing step 304. A difference lies in that it is not specified which data receiving STA for which the sending opportunity carried in the beacon frame broadcast in the foregoing step 304 is allocated, but in this step 503, the sending opportunity carried in the broadcast beacon frame corresponds to a data receiving STA. That is, in this embodiment, the AP defines a sending opportunity corresponding to each data receiving STA. Therefore, in order to ensure that a sending opportunity subsequently selected by the STA is a sending opportunity corresponding to the STA, in this step 503, the beacon frame broadcast by the AP further indicates a mapping relationship between each sending opportunity and each data receiving STA in addition to carrying the sending opportunity. A manner of indicating a mapping relationship between each sending opportunity and each data receiving STA includes but is not limited to: numbering an indicated trigger message sending opportunity in advance; and establishing, according to a sequence number of a bit “1”, corresponding to a data receiving STA in a TIM element, in all bits “1” in the TIM element, a mapping relationship between a sequential number of each sending opportunity and a sequence number of a bit “1”, corresponding to each data receiving STA, in all bits “1” in the TIM element, for example, first sequentially numbering M sending opportunities from 1. If a bit “1”, corresponding to a STA, in the TIM element is the third bit “1” in the TIM element, the STA uses a sending opportunity whose number is 3 to send a trigger message. Because each binary bit on an indication bit in the TIM element is in one-to-one correspondence with a STA, a mapping relationship between each sending opportunity and each data receiving STA may be indicated by establishing a mapping relationship between a sending opportunity and a sequence number of a binary bit on the indication bit in the TIM element.

504: The STA receives the beacon frame broadcast by the AP, determines, according to indication information in the beacon frame, a trigger message sending opportunity corresponding to the STA, and sends a PS-POLL message to the AP according to the specified sending opportunity.

In this step, a STA in a power saving mode may wake up according to a cycle agreed with the AP to receive the beacon frame. If the STA is a data receiving STA, the STA may determine a sending opportunity according to the indication information in the beacon frame. A mapping relationship exists between each sending opportunity in the beacon frame and each data receiving STA, that is, the sending opportunity carried in the beacon frame broadcast by the AP corresponds to the data receiving STA, and the sending opportunity is sequentially numbered in advance, for example, may be sequentially numbered from 1. Therefore, a sending opportunity corresponding to each data receiving STA may be determined according to the AP beacon frame. During the specific determining, after receiving the beacon frame broadcast by the AP, if it is confirmed that a value of a corresponding binary bit on the indication bit in the TIM element is “1” and a sequence number of a binary bit “1”, corresponding to the STA, in all bits “1” in the TIM element is n, the STA determines, from M sending opportunities indicated in the received beacon frame, the n^{th} sending opportunity as the sending opportunity corresponding to the STA. Because the M sending opportunities in this step is in one-to-one correspondence with M data receiving STAs, where values of binary bits corresponding to the M STAs on the indication bit in the TIM element are 1, a conflict caused by sending PS-Poll messages by two data receiving STAs by using a same sending opportunity does not exist. Certainly, in addition to using a corresponding binary bit whose value is “1” on the indication bit in the TIM element, a value “0” may also be used to identify whether a corresponding STA is a data receiving STA. This embodiment poses no limitation on a manner of identifying, by using a value of a binary bit on the indication bit in the TIM element, whether a corresponding STA is a data receiving STA.

Further, after determining the sending opportunity corresponding to the data receiving STA, the data receiving STA sends the PS-POLL message to the AP by using the specified sending opportunity.

505: The AP receives the PS-POLL message sent by the data receiving STA, and allocates, for the STA sending the received PS-POLL message, a channel resource used to receive data, where the STA sending the received PS-POLL message sends the received PS-POLL message according to a sending opportunity specified in the PS-POLL message sending window that is carried in the beacon frame.

In this step, because a sending opportunity selected by each data receiving STA from the beacon frame is a sending opportunity corresponding to the STA, the PS-POLL message received by the AP is also a PS-POLL message that is sent by the STA by using the specified sending opportunity. In this case, a conflict does not occur between PS-POLL messages that are sent by STAs and received by the AP.

A principle of a manner used by the AP to allocate, for the STA sending the received PS-POLL message, a channel resource used to receive data is same as that of the implementation manner of step 306 in the foregoing Embodiment 2. Reference may be specifically made to the content of step 306 in the foregoing Embodiment 2, and details are not described herein again.

506: The AP returns channel resource allocation information to the STA sending the received PS-POLL message, and sends, by using the allocated channel resource, the data to the STA sending the received PS-POLL message, so that the STA sending the received PS-POLL message receives, according to the channel resource allocation information, the data on the channel resource allocated for the STA sending the received PS-POLL message, where the channel resource includes a subchannel that is used and corresponding use time.

A principle of a specific implementation manner of this step is same as that of the implementation manner of step 307 in the foregoing Embodiment 2. Reference may be made to the content of step 307 in the foregoing Embodiment 2, and details are not described herein again.

507: The STA receives the channel resource allocation information that is returned by the AP, and receives, according to the channel resource allocation information, the data that is sent by the AP by using the allocated channel resource.

A principle of a specific implementation manner of this step is same as that of the implementation manner of step 308 in the foregoing Embodiment 2. Reference may be made to the content of step 308 in the foregoing Embodiment 2, and details are not described herein again.

Further, in order to enable the AP to confirm a data transmission result, in the method provided in this embodiment, after successfully receiving the data transmitted by the AP, the STA further sends an ACK message to the AP, so that after receiving the ACK message sent by the STA, the AP confirms, according to the ACK message, that a transmission process of the data transmitted for the STA is complete. The STA may send, within preset time after the data transmission is complete, the ACK message to the AP on the subchannel used when the data sent by the AP is received; or the STA may also concurrently send, within preset time after the data transmission is complete, the ACK message to the AP on the subchannel used when the PS-POLL message is sent. Certainly, another manner may also be available to send the ACK message, which is not specifically limited in this embodiment. Likewise, a length of the preset time is not limited either.

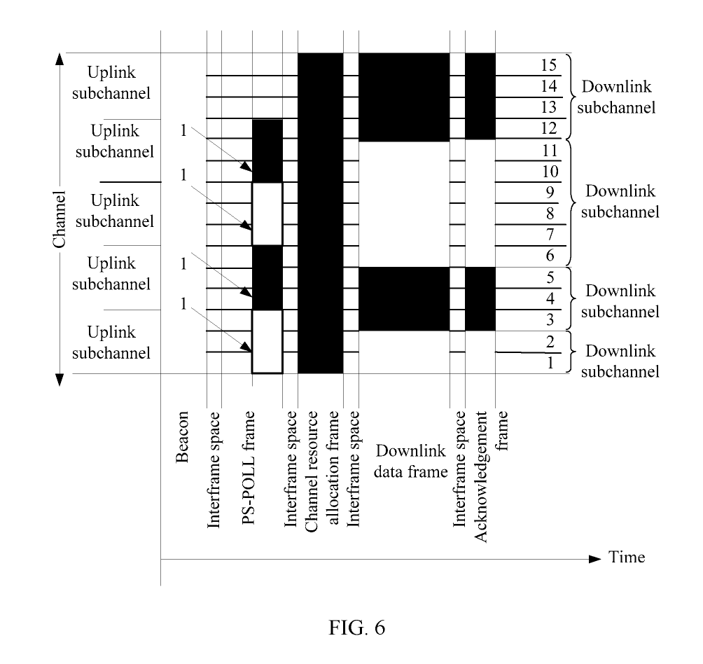

For ease of understanding of the foregoing data transmission process, detailed explanations and descriptions are provided with reference to FIG. 6.

It can be seen from FIG. 6 that a channel is divided into 15 subcarriers, where the 15 subcarriers are first grouped into five uplink subchannels and each uplink subchannel includes three subcarriers. An AP determines, according to an amount of data, that a quantity of data receiving STAs is 4, further determines that a quantity of sending opportunities carried in a to-be-broadcast beacon frame is 4, and indicates, by setting a value of a binary indication bit in a TIM element to “1” in the broadcast beacon frame, which STAs are data receiving STAs. The AP broadcasts one beacon frame by using the entire channel. The beacon frame indicates that there are four sending opportunities, and indicates, by using the TIM element, that there are four data receiving STAs, that is, values of binary bits corresponding to the four STAs in the TIM element are set to “1”, which indicates that STAs corresponding to the four binary bits on the indication bit in the TIM element are data receiving STAs, that is, there are four data receiving STAs. In addition, a mapping relationship between each sending opportunity and each data receiving STA is further defined. After receiving the beacon frame broadcast by the AP, a STA in a network determines, according to the indication bit in the TIM element in the beacon frame, whether the STA is a data receiving STA. A STA that is determined as a data receiving STA determines, according to an indicated or preset mapping relationship, one specified sending opportunity corresponding to the STA from the four sending opportunities carried in the beacon frame broadcast by the AP, and sends a PS-POLL message to the AP by using the specified sending opportunity. After successfully receiving the PS-POLL message sent by the STA, the AP broadcasts, by using the entire channel, a channel resource allocation frame carrying information about channel resources allocated for all STAs sending received PS-POLL message, where each piece of channel resource information includes a corresponding STA identifier, so as to indicate the channel resource allocated by the AP for the four STAs that successfully send the PS-POLL message. After receiving the channel resource allocation frame broadcast by the AP, each STA determines, according to the STA identifier included in the channel resource information carried in the channel resource allocation frame, whether the channel resource is a channel resource allocated by the AP for the STA. After the four STAs sending the received PS-OLL message determine their respective corresponding channel resource information, where the channel resource information includes data receiving time and subcarrier information, the four STAs sending the received PS-POLL message may receive, at corresponding data receiving time and on a corresponding subchannel, the data that is transmitted by the AP for the STAs. When the AP transmits the data, the entire channel is divided into four downlink subchannels, and a quantity of subcarriers included in each subchannel is divided according to a size of the data received by each STA. Further, in order to enable the AP to confirm a data transmission result, in the method provided in this embodiment, after successfully receiving the data transmitted by the AP, the STA further sends an ACK (Acknowledgement, acknowledgement) message to the AP, so that after receiving the ACK message sent by the STA, the AP confirms, according to the ACK message, that a transmission process of the data transmitted for the STA is complete. The STA may send, within preset time after the data transmission is complete, the ACK message to the AP on the subchannel used when the data sent by the AP is received; or the STA may also concurrently send, within preset time after the data transmission is complete, the ACK message to the AP on the subchannel used when the PS-POLL message is sent. Certainly, another manner may also be available to send the ACK message, which is not specifically limited in this embodiment. Likewise, a length of the preset time is not limited either.

According to the method provided in this embodiment, a broadcast message carries a sending opportunity that is allocated for each data receiving terminal and that includes trigger message sending time and subcarrier information, so that multiple data receiving terminals may simultaneously send trigger messages according to a sending opportunity specified in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### Embodiment 4

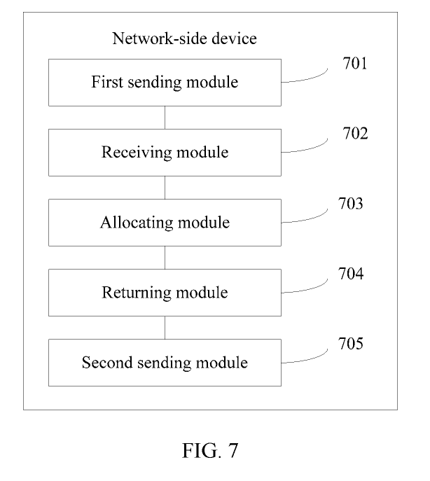

Referring to FIG. 7, this embodiment of the present invention provides a network-side device, where the device includes:

a first sending module 701, configured to send a broadcast message, where the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

a receiving module 702, configured to receive the trigger message sent by the data receiving terminal;

an allocating module 703, configured to allocate, for the terminal sending the received trigger message, a channel resource used to receive data, where the terminal sending the received trigger message sends the received trigger message according to the at least one sending opportunity in the trigger message sending window that is carried in the broadcast message;

a returning module 704, configured to return channel resource allocation information to the terminal sending the received trigger message; and

a second sending module 705, configured to send, by using the allocated channel resource, the data to the terminal sending the received trigger message, so that the terminal sending the received trigger message receives, according to the channel resource allocation information, the data on the channel resource allocated for the terminal sending the received trigger message, where the channel resource includes a subchannel that is used and corresponding use time.

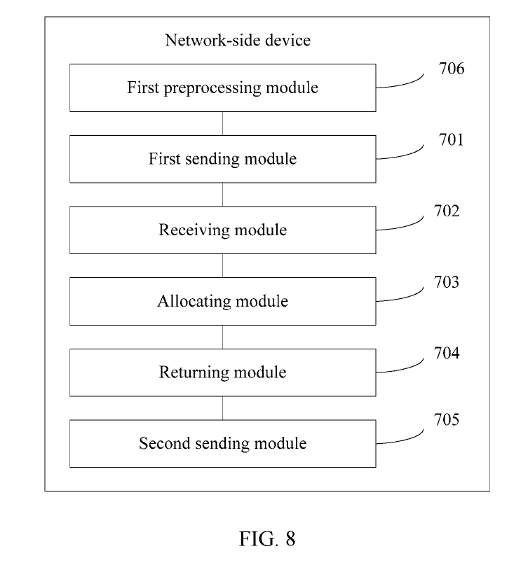

Referring to FIG. 8, the device further includes:

a first preprocessing module 706, configured to: divide a channel into a preset quantity of subchannels, and determine a subcarrier included in each subchannel; and determine a quantity of data receiving terminals, and determine a quantity of sending opportunities according to the quantity of data receiving terminals, where the sending opportunity is determined by the trigger message sending time and the subchannel that is used.

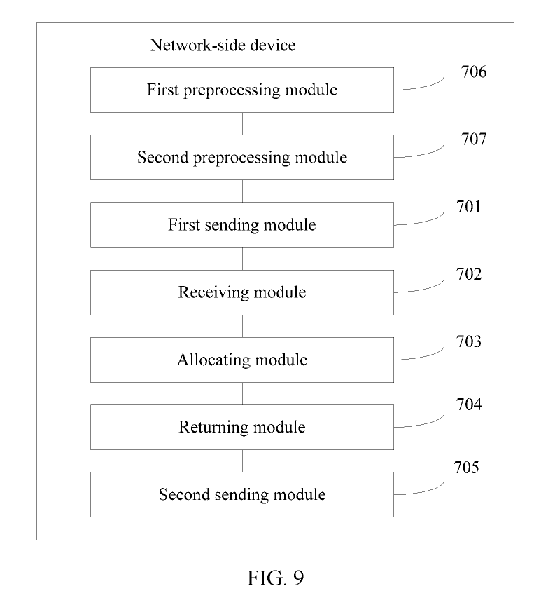

Referring to FIG. 9, the device further includes:

a second preprocessing module 707, configured to: divide a channel into a preset quantity of subchannels, and determine a subcarrier included in each subchannel; and allocate a corresponding trigger message sending opportunity for each data receiving terminal, so that information about the allocated trigger message sending opportunity is carried in the subsequently sent broadcast message.

According to the device provided in this embodiment of the present invention, a broadcast message carries a sending opportunity that is allocated for a data receiving terminal and that includes trigger message sending time and information about a subchannel that is used, and the broadcast message is sent, so that multiple data receiving terminals may simultaneously send trigger messages according to at least one sending opportunity in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### Embodiment 5

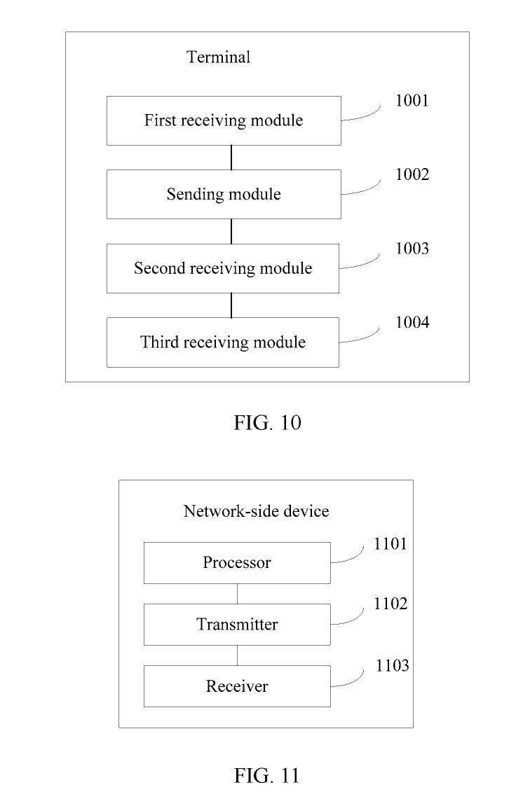

Referring to FIG. 10, this embodiment of the present invention provides a terminal, where the terminal includes:

a first receiving module 1001, configured to receive a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

a sending module 1002, configured to send the trigger message to the network-side device according to the at least one sending opportunity in the trigger message sending window that is carried in the broadcast message, so that the network-side device allocates a channel resource used to receive data, where the channel resource includes a subchannel that is used and corresponding use time;

a second receiving module 1003, configured to receive channel resource allocation information that is returned by the network-side device; and

a third receiving module 1004, configured to receive, according to the allocation information, the data on the channel resource allocated by the network-side device.

In an exemplary embodiment, the sending module 1002 is configured to send the trigger message to the network-side device according to at least one sending opportunity randomly selected from the trigger message sending window that is carried in the broadcast message.

In an exemplary embodiment, the selection module 1002 is configured to send the trigger message to the network-side device according to a sending opportunity specified in the trigger message sending window that is carried in the broadcast message.

According to the terminal provided in this embodiment, a broadcast message that is sent by a network-side device and that carries a sending opportunity is received, where the sending opportunity is allocated for a data receiving terminal and includes trigger message sending time and information about a subchannel that is used, so that multiple data receiving terminals simultaneously send trigger messages according to at least one sending opportunity in a trigger message sending window that is carried in the broadcast message, and the network-side device concurrently transmits data to the multiple terminals, thereby saving channel resources and improving a utilization rate of the channel resources.

### Embodiment 6

FIG. 11 is a schematic structural diagram of a network-side device in an implementation manner. The network-side device includes a processor 1101, a transmitter 1102, and a receiver 1103, where

the processor 1101 is configured to generate a broadcast message, and allocate, for a terminal sending a received trigger message, a channel resource used to receive data, where the channel resource includes a subchannel that is used and corresponding use time, the broadcast message carries information about a sending window that is allocated for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

the transmitter 1102 is configured to: send the broadcast message, generate allocation information about the channel resource that is allocated for the terminal sending the received trigger message, and return the channel resource allocation information to the terminal sending the received trigger message; and generate data that is to be sent to the terminal sending the received trigger message, and send, by using the allocated channel resource, the data to the terminal sending the received trigger message, so that the terminal sending the received trigger message receives, according to the channel resource allocation information, the data on the channel resource allocated for the terminal sending the received trigger message; and

the receiver 1103 is configured to receive the trigger message sent by the data receiving terminal, where the terminal sending the received trigger message sends the received trigger message according to the at least one sending opportunity in the trigger message sending window that is carried in the broadcast message.

In an exemplary embodiment, the processor 1101 is further configured to: divide a channel into a preset quantity of subchannels, and determine a subcarrier included in each subchannel; and determine a quantity of data receiving terminals, and determine a quantity of sending opportunities according to the quantity of data receiving terminals, where the sending opportunity is determined by the trigger message sending time and the subchannel that is used.

In an exemplary embodiment, the processor 1101 is further configured to: divide a channel into a preset quantity of subchannels, and determine a subcarrier included in each subchannel; and allocate a corresponding trigger message sending opportunity for each data receiving terminal, so that information about the allocated trigger message sending opportunity is carried in the subsequently sent broadcast message.

The network-side device may specifically be an access point (AP) of a WiFi network, and certainly, is not limited to this. The processor of the network-side device may be a single processor, may be multiple processors, may be a single-core processor, or may be a multi-core processor.

According to the device provided in this embodiment of the present invention, a broadcast message carries a sending opportunity that is allocated for a data receiving terminal and that includes trigger message sending time and information about a subchannel that is used, and the broadcast message is sent, so that multiple data receiving terminals may simultaneously send trigger messages according to at least one sending opportunity in a trigger message sending window that is carried in the broadcast message, to trigger a network-side device to simultaneously allocate channel resources for the multiple terminals sending the trigger message, so as to concurrently transmit data to the multiple terminals, thereby saving channel resources and improving a utilization rate of the channel resources.

### Embodiment 7

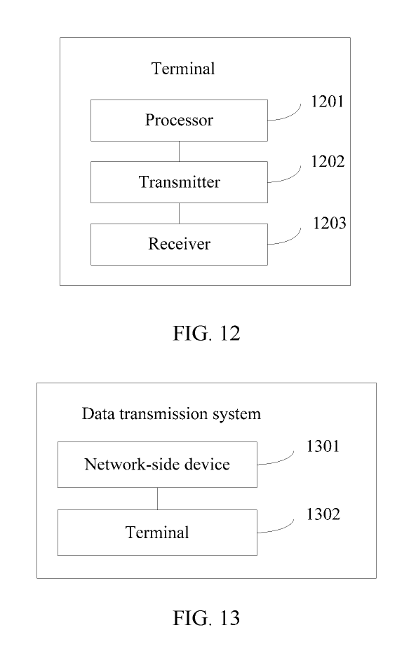

FIG. 12 is a schematic structural diagram of a terminal in an implementation manner. The terminal includes a processor 1201, a transmitter 1202, and a receiver 1203, where

the receiver 1203 is configured to receive a broadcast message sent by a network-side device, where the broadcast message carries information about a sending window that is allocated by the network-side device for a data receiving terminal and that is used to send a trigger message, the trigger message sending window includes at least one sending opportunity used by the data receiving terminal to send the trigger message, the sending opportunity includes trigger message sending time and information about a subchannel that is used, and the subchannel includes at least one subcarrier;

the processor 1201 is configured to control, according to the at least one sending opportunity in the trigger message sending window that is carried in the broadcast message, the transmitter 1202 to send the trigger message to the network-side device, so that the network-side device allocates a channel resource used to receive data, where the channel resource includes a subchannel that is used and corresponding use time; and

the receiver 1203 is further configured to receive channel resource allocation information that is returned by the network-side device, and receive, according to the allocation information, the data on the channel resource allocated by the network-side device.

In an exemplary embodiment, that the processor 1201 controls, according to the at least one sending opportunity in the trigger message sending window that is carried in the broadcast message, the transmitter 1202 to send the trigger message to the network-side device specifically includes: controlling, according to at least one sending opportunity randomly selected from the trigger message sending window that is carried in the broadcast message, the transmitter 1202 to send the trigger message to the network-side device.

In an exemplary embodiment, that the processor 1201 controls, according to the at least one sending opportunity in the trigger message sending window that is carried in the broadcast message, the transmitter 1202 to send the trigger message to the network-side device specifically includes: controlling, according to at least one sending opportunity specified in the trigger message sending window that is carried in the broadcast message, the transmitter 1202 to send the trigger message to the network-side device.

The terminal may specifically be an electronic device such as a mobile phone, a tablet computer, an MP3/MP4 player, a personal computer, and an e-reader, and especially, may be any device that has a wireless network accessing capability. The processor of the terminal may be a single processor, may be multiple processors, may be a single-core processor, or may be a multi-core processor.

According to the terminal provided in this embodiment, a broadcast message that is sent by a network-side device and that carries a sending opportunity is received, where the sending opportunity is allocated for a data receiving terminal and includes trigger message sending time and information about a subchannel that is used, so that multiple data receiving terminals simultaneously send trigger messages according to at least one sending opportunity in a trigger message sending window that is carried in the broadcast message, and the network-side device concurrently transmits data to the multiple terminals, thereby saving channel resources and improving a utilization rate of the channel resources.

### Embodiment 8

This embodiment provides a data transmission system. Referring to FIG. 13, the system includes: a network-side device 1301 and a terminal 1302.

The network-side device 1301 is similar to the network-side device provided in the foregoing Embodiment 6. Reference may be made to the content of the foregoing Embodiment 6, and details are not described herein again.

The terminal 1302 is similar to the terminal provided in the foregoing Embodiment 7. Reference may be made to the content of the foregoing Embodiment 7, and details are not described herein again.

According to the system provided in this embodiment, a network-side device carries, in a broadcast message, a sending opportunity that is allocated for a data receiving terminal and that includes trigger message sending time and information about a subchannel that is used, and sends the broadcast message, so that multiple data receiving terminals may simultaneously send trigger messages according to at least one sending opportunity in the broadcast message, to trigger the network-side device to simultaneously allocate channel resources for multiple terminals that successfully send the trigger message, so as to concurrently transmit data to the multiple terminals, thereby saving channel resources and improving a utilization rate of the channel resources.

It should be noted that, when the network-side device and the terminal that are provided in the foregoing embodiments transmit data, division of the foregoing functional modules is just used as an example for description, and in an actual application, the forgoing functions may be implemented by different functional modules as required, that is, internal structures of the network-side device and the terminal are divided into different functional modules to implement a part of or all the foregoing described functions. In addition, the network-side device, the terminal, the data transmission system, and the data transmission method that are provided in the foregoing embodiments are based on a same idea. For their specific implementation processes, reference may be made to the method embodiments, and details are not described herein again.

The sequence numbers of the foregoing embodiments of the present invention are merely for illustrative purposes, and are not intended to indicate priorities of the embodiments.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

1. A data transmission method, comprising:
sending a broadcast message, wherein the broadcast message carries information about a sending window that is allocated for a data receiving terminal and that is used to send a trigger message, the trigger message sending window comprises at least one sending opportunity used by the data receiving terminal to send the trigger message, the at least one sending opportunity comprises trigger message sending time and information about a subchannel that is used, and the subchannel comprises at least one subcarrier;
receiving the trigger message sent by the data receiving terminal, and allocating, for the terminal sending the received trigger message, a channel resource used to receive data, wherein the terminal sending the received trigger message sends the received trigger message according to the at least one sending opportunity in the trigger message sending window that is carried in the broadcast message; and
returning channel resource allocation information to the terminal sending the received trigger message, and sending, by using the allocated channel resource, the data to the terminal sending the received trigger message, so that the terminal sending the received trigger message receives, according to the channel resource allocation information, the data by using the channel resource allocated for the terminal sending the received trigger message, wherein the channel resource comprises a subchannel that is used and corresponding use time.

2. The method according to claim 1, wherein before the sending a broadcast message, the method further comprises:
dividing a channel into a preset quantity of subchannels, and determining a quantity of subcarriers comprised in each subchannel; and
determining a quantity of data receiving terminals, and determining a quantity of sending opportunities according to the quantity of data receiving terminals, wherein the sending opportunity is determined by the trigger message sending time and the subchannel that is used.

3. The method according to claim 1, wherein before the sending a broadcast message, the method further comprises:
dividing a channel into a preset quantity of subchannels, and determining a subcarrier comprised in each subchannel; and
allocating a corresponding trigger message sending opportunity for each data receiving terminal, so that information about the allocated trigger message sending opportunity is carried in the subsequently sent broadcast message.

4. A data transmission method, wherein the method comprises:
receiving a broadcast message sent by a network-side device, wherein the broadcast message carries information about a sending window that is allocated by the network-side device for a data receiving terminal and that is used to send a trigger message, the trigger message sending window comprises at least one sending opportunity used by the data receiving terminal to send the trigger message, the sending opportunity comprises trigger message sending time and information about a subchannel that is used, and the subchannel comprises at least one subcarrier;
sending the trigger message to the network-side device according to the at least one sending opportunity in the trigger message sending window that is carried in the broadcast message, so that the network-side device allocates a channel resource used to receive data, wherein the channel resource comprises a subchannel that is used and corresponding use time; and
receiving channel resource allocation information that is returned by the network-side device, and receiving, according to the allocation information, the data on the channel resource allocated by the network-side device.

5. The method according to claim 4, wherein the sending the trigger message to the network-side device according to the at least one sending opportunity in the trigger message sending window that is carried in the broadcast message comprises:
sending the trigger message to the network-side device according to at least one sending opportunity randomly selected from the trigger message sending window that is carried in the broadcast message.

6. The method according to claim 4, wherein the sending the trigger message to the network-side device according to the at least one sending opportunity in the trigger message sending window that is carried in the broadcast message comprises:
sending the trigger message to the network-side device according to a sending opportunity specified in the trigger message sending window that is carried in the broadcast message.

7-12. (canceled)

13. A network-side device, wherein the network-side device comprises a processor, a transmitter, and a receiver, wherein
the processor is configured to generate a broadcast message, and allocate, for a terminal sending a received trigger message, a channel resource used to receive data, wherein the channel resource comprises a subchannel that is used and corresponding use time, the broadcast message carries information about a sending window that is allocated for a data receiving terminal and that is used to send a trigger message, the trigger message sending window comprises at least one sending opportunity used by the data receiving terminal to send the trigger message, the sending opportunity comprises trigger message sending time and information about a subchannel that is used, and the subchannel comprises at least one subcarrier;
the transmitter is configured to: send the broadcast message, generate allocation information about the channel resource that is allocated for the terminal sending the received trigger message, and return the channel resource allocation information to the terminal sending the received trigger message; and generate data that is to be sent to the terminal sending the received trigger message, and send, by using the allocated channel resource, the data to the terminal sending the received trigger message, so that the terminal sending the received trigger message receives, according to the channel resource allocation information, the data on the channel resource allocated for the terminal sending the received trigger message; and
the receiver is configured to receive the trigger message sent by the data receiving terminal, wherein the terminal sending the received trigger message sends the received trigger message according to the at least one sending opportunity in the trigger message sending window that is carried in the broadcast message.

14. The device according to claim 13, wherein the processor is further configured to: divide a channel into a preset quantity of subchannels, and determine a subcarrier comprised in each subchannel; and determine a quantity of data receiving terminals, and determine a quantity of sending opportunities according to the quantity of data receiving terminals, wherein the sending opportunity is determined by the trigger message sending time and the subchannel that is used.

15. The device according to claim 13, wherein the processor is further configured to: divide a channel into a preset quantity of subchannels, and determine a subcarrier comprised in each subchannel; and allocate a corresponding trigger message sending opportunity for each data receiving terminal, so that information about the allocated trigger message sending opportunity is carried in the subsequently sent broadcast message.

16. A terminal, wherein the terminal comprises a processor, a transmitter, and a receiver, wherein
the receiver is configured to receive a broadcast message sent by a network-side device, wherein the broadcast message carries information about a sending window that is allocated by the network-side device for a data receiving terminal and that is used to send a trigger message, the trigger message sending window comprises at least one sending opportunity used by the data receiving terminal to send the trigger message, the sending opportunity comprises trigger message sending time and information about a subchannel that is used, and the subchannel comprises at least one subcarrier;
the processor is configured to control, according to the at least one sending opportunity in the trigger message sending window that is carried in the broadcast message, the transmitter to send the trigger message to the network-side device, so that the network-side device allocates a channel resource used to receive data, wherein the channel resource comprises a subchannel that is used and corresponding use time; and
the receiver is further configured to receive channel resource allocation information that is returned by the network-side device, and receive, according to the allocation information, the data on the channel resource allocated by the network-side device.

17. The terminal according to claim 16, wherein the controlling, according to the at least one sending opportunity in the trigger message sending window that is carried in the broadcast message, the transmitter to send the trigger message to the network-side device specifically comprises: controlling, according to at least one sending opportunity randomly selected from the trigger message sending window that is carried in the broadcast message, the transmitter to send the trigger message to the network-side device.

18. The terminal according to claim 16, wherein the controlling, according to the at least one sending opportunity in the trigger message sending window that is carried in the broadcast message, the transmitter to send the trigger message to the network-side device specifically comprises: controlling, according to at least one sending opportunity specified in the trigger message sending window that is carried in the broadcast message, the transmitter to send the trigger message to the network-side device.
